(19) United States
(12) Patent Application Publication
(10) Pub. No.: US 2025/0332860 A1
(43) Pub. Date: Oct. 30, 2025

(54) ORGANIZATION SYSTEM

(71) Applicant: Plstic Studio Inc., Oakville (CA)

(72) Inventor: Sanjiv Sirpal, Oakville (CA)

(73) Assignee: Plstic Studio Inc., Oakville (CA)

(21) Appl. No.: 19/192,753

(22) Filed: Apr. 29, 2025

Related U.S. Application Data
(60) Provisional application No. 63/640,065, filed on Apr. 29, 2024.

(51) Int. Cl. B43M 99/00; B65D 21/02

(52) U.S. Cl. CPC B43M 99/001; B65D 21/0235

(57) ABSTRACT

An organization system may include an attachment body connected to a base. The base may include a slot configured to demountably connect a stem of the attachment body to the base. The attachment body may include a receptacle having a cavity for the storage and/or organization of office supplies and/or stationery. The receptacle may be sized to extend outwardly from the base and create a void between the receptacle and a working surface. The attachment body may further include a stem configured to demountably connect to the base within the slot. A plurality of receptacles of different dimensions may be connected to the base. The organization system may include a first receptacle configured to demountably connect to a second receptacle in order to form a stacked arrangement. The organization system may include one or more trays configured to demountably connect to the attachment body.

### CROSS-REFERENCE TO RELATED APPLICATIONS

This U.S. non-provisional application claims priority in U.S. Provisional Patent Application Ser. No. 63/640,065, filed Apr. 29, 2024. The contents of identified earlier-filed application are hereby incorporated by reference into the present application.

### FIELD OF THE DISCLOSED SUBJECT MATTER

The disclosed subject matter generally relates to organization systems, and more particularly, desktop organization systems.

### SUMMARY

In some aspects, the disclosed subject matter described herein relates to an organization system including: a base including: a top surface; a bottom surface approximately parallel to the top surface; and a slot extending downwardly from the top surface; and an attachment body having a stem, wherein the stem is configured to be secured within the slot.

In some aspects, the disclosed subject matter described herein relates to an organization system, wherein the base includes an exterior sidewall extending outwardly between the top surface and the bottom surface.

In some aspects, the disclosed subject matter described herein relates to an organization system, wherein the base includes a pair of end sections connected between a front face and a rear face of the base, wherein each end section of the pair of end sections are curved between the front face and the rear face.

In some aspects, the disclosed subject matter described herein relates to an organization system, wherein the attachment body includes: a receptacle having a length, a width, and a height; and a cavity extending downwardly into the receptacle.

In some aspects, the disclosed subject matter described herein relates to an organization system, wherein the length is approximately equal to the width.

In some aspects, the disclosed subject matter described herein relates to an organization system, wherein the length is greater than the width.

In some aspects, the disclosed subject matter described herein relates to an organization system, wherein the length is greater than the height.

In some aspects, the disclosed subject matter described herein relates to an organization system, wherein a portion of the receptacle laterally extends a first distance from the base; wherein the first distance is between about 0 and 80 percent of the length.

In some aspects, the disclosed subject matter described herein relates to an organization system, wherein in the length is greater than the height, and wherein the height is greater than the width.

In some aspects, the disclosed subject matter described herein relates to an organization system, wherein a midpoint of the stem is offset a predetermined distance from the midpoint of the receptacle.

In some aspects, the disclosed subject matter described herein relates to an organization system, further including a second receptable configured to connect to the receptacle.

In some aspects, the disclosed subject matter described herein relates to an organization system including: a pair of bases, each base of the pair of bases having a slot; and a plurality of receptacles connected to the pair of bases, wherein a void is formed below the plurality of receptacles.

In some aspects, the disclosed subject matter described herein relates to an organization system, wherein each receptacle of the plurality of receptacles includes a cavity extending along a portion of a length of the receptacle.

In some aspects, the disclosed subject matter described herein relates to an organization system including: a first tray including: a first compartment; and a first slot parallel to the first compartment; and an accessory configured to partially fit within the first slot.

In some aspects, the disclosed subject matter described herein relates to an organization system, wherein the accessory includes a card rail.

In some aspects, the disclosed subject matter described herein relates to an organization system, wherein the accessory includes a storage compartment.

In some aspects, the disclosed subject matter described herein relates to an organization system, wherein the accessory includes a storage container having a plurality of storage bins.

In some aspects, the disclosed subject matter described herein relates to an organization system, further including a desk mat for supporting the first tray.

In some aspects, the disclosed subject matter described herein relates to an organization system, further including: a second tray including: a second compartment; and a second slot parallel to the second compartment; and an accessory configured to partially fit within the second slot.

In some aspects, the disclosed subject matter described herein relates to an organization system, further including a desk mat for supporting the first tray and the second tray.

### BRIEF DESCRIPTION OF THE DRAWINGS

The present disclosed subject matter is described herein with reference to the following drawing figures, with greater emphasis being placed on clarity rather than scale:

FIG. 1 is a perspective view of an organization system in accordance with an embodiment of the disclosed subject matter.

FIG. 2 is a perspective view of a base in accordance with an embodiment of the disclosed subject matter.

FIG. 3 is a perspective view of a base in accordance with an embodiment of the disclosed subject matter.

FIG. 4 is a perspective view of a base in accordance with an embodiment of the disclosed subject matter.

FIG. 5 is a perspective view of an organization system in accordance with an embodiment of the disclosed subject matter.

FIG. 6 is a perspective view of an organization system in accordance with an embodiment of the disclosed subject matter.

FIG. 7 is a perspective view of an organization system in accordance with an embodiment of the disclosed subject matter.

FIG. 8 is a perspective view of an organization system in accordance with an embodiment of the disclosed subject matter.

FIG. 9 is a perspective view of an organization system in accordance with an embodiment of the disclosed subject matter.

FIG. 10 is a perspective view of an organization system in accordance with an embodiment of the disclosed subject matter.

FIG. 11 is a perspective view of an organization system in accordance with an embodiment of the disclosed subject matter.

FIG. 12 is a perspective view of an organization system in accordance with an embodiment of the disclosed subject matter.

FIG. 13 is a perspective view of an organization system in accordance with an embodiment of the disclosed subject matter.

FIG. 14 is a perspective view of an organization system in accordance with an embodiment of the disclosed subject matter.

FIG. 15 is a perspective view of an organization system in accordance with an embodiment of the disclosed subject matter.

FIG. 16 is a perspective view of an organization system in accordance with an embodiment of the disclosed subject matter.

FIG. 17 is a perspective view of an organization system in accordance with an embodiment of the disclosed subject matter.

FIG. 18 is a perspective view of an organization system in accordance with an embodiment of the disclosed subject matter.

FIG. 19. is a perspective view of an organization system in accordance with an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

Although the subject matter has been disclosed with reference to various particular embodiments, it is understood that equivalents may be employed and substitutions made herein without departing from the scope of the subject matter.

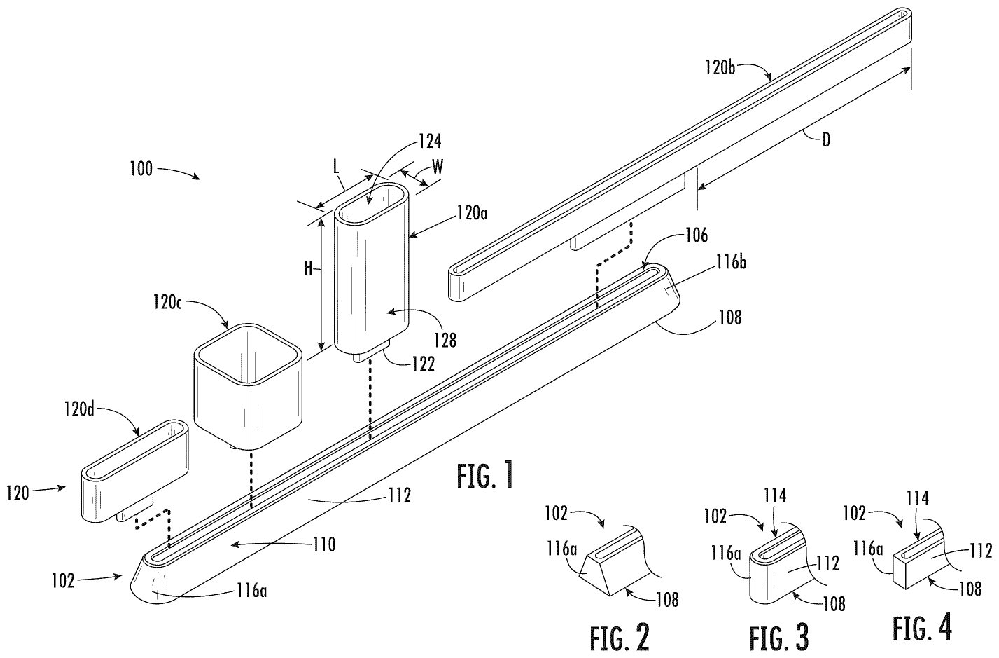

Referring to the drawings, FIG. 1 shows an embodiment of an organization system 100 having a base 102 and an attachment body 104. The base 102 having a top surface 106, a bottom surface 108 approximately parallel to the top surface 106, and an exterior sidewall 110 extending between the top surface 106 and the bottom surface 108. The exterior sidewall 110 may taper upwardly from the bottom surface 108 to the top surface 106 to provide stability to the base 102. The exterior sidewall 110 may comprise a front face 112, a rear face (not shown), and a pair of end sections 116a-b connected between the front face 112 and the rear face at distal ends of the base 102. In an embodiment of the disclosed subject matter, the pair of end sections 116a-b are both tapered and curved to create rounded corners connected between the front face 112 and the rear face of the base 102.

In an embodiment of the disclosed subject matter, the attachment body 104 may comprise a receptacle 120a-d and a stem 122 extending outwardly from the receptacle 120. The receptacle 120 may take the form of different geometric shapes having various heights H, lengths L and widths W depending on the application. For example, the receptacle 120a may comprise a height H being greater than length L and/or width W. In another embodiment, the receptacle 120b may comprise a length L being greater than the height H and/or the width W. In another embodiment, a receptacle 120c may comprise a length L approximately equal to the width W. In another embodiment, a receptacle 120d may comprise a length L greater than the height H, wherein the height H is greater than the width W. It is to be understood that the receptacle may comprise different shapes and sizes depending on the application.

The stem 122 may be demountably connected to the base 102 within the slot 118. In an embodiment, the stem 122 may be elongated and configured resist rotation withing the slot 118. In other embodiments, the cross-section shape of the stem 122 may comprise one of a rectangular, square, and circular shape. A cavity 124 may be formed within the receptacle 120 bounded by a bottom member (not shown) and a perimeter wall 128 extending upwardly from the bottom member. Depending on the application, the cross-sectional area of the cavity 124 may take various shapes such as, by way of example, a square, a rectangle, a circle, a triangle, a polygon, and an oval, and may include rounded, straight, and beveled edges.

In an embodiment of the disclosed subject matter, the midpoint of the stem 122 may be offset a predetermined distance from the midpoint of the receptacles 120a-d. The stem 122 may be located on the bottom of a receptacles 120a-d so that at least a portion of the receptacles 120a-d laterally extends a first distance D from the base 102 as shown in FIG. 1. In an embodiment, the first distance D may be between about 0 and 40 inches. In an embodiment of the disclosed subject matter, the first distance D is between about 0 and 80 percent of the length L. In another embodiment of the disclosed subject matter, the first distance D is between about 50 and 60 percent of the length L. In an embodiment of the disclosed subject matter, the attachment body 104 may be constructed of wood, metal, or plastic and the stem 122 is configured to fit within the slot 118.

Referring to the drawings, FIG. 2 shows an embodiment of the base 102 wherein the pair of end sections 116a-b is perpendicular to the bottom surface 108.

Referring to the drawings, FIG. 3 shows an embodiment of the base 102 wherein the front face 112 and the rear face 114 are generally parallel to each other and the pair of end sections 116a-b is perpendicular to the bottom surface 108.

Referring to the drawings, FIG. 4 shows an embodiment of the base 102 wherein the front face 112 and rear face 114 are generally parallel to each other and the pair of end sections 116a-b is perpendicular to each of the front face 112, the rear face 114, and the bottom surface 108.

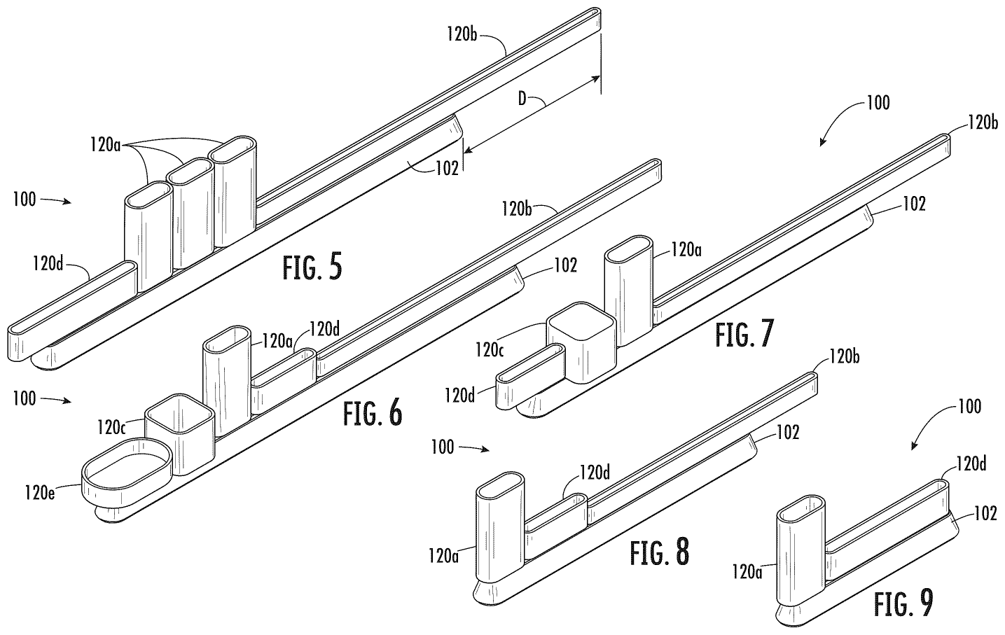

Referring to the drawings, FIGS. 5-9 show various embodiments of the organization system 100 having a base 102 and receptacles 120a-e connected to the base 102. It is to be understood that the base 102 may vary in length to accommodate a different number of receptacles 120. Based on the application, the receptacles 120a-e may be connected to the base at different positions along the slot (not shown) of the base 102.

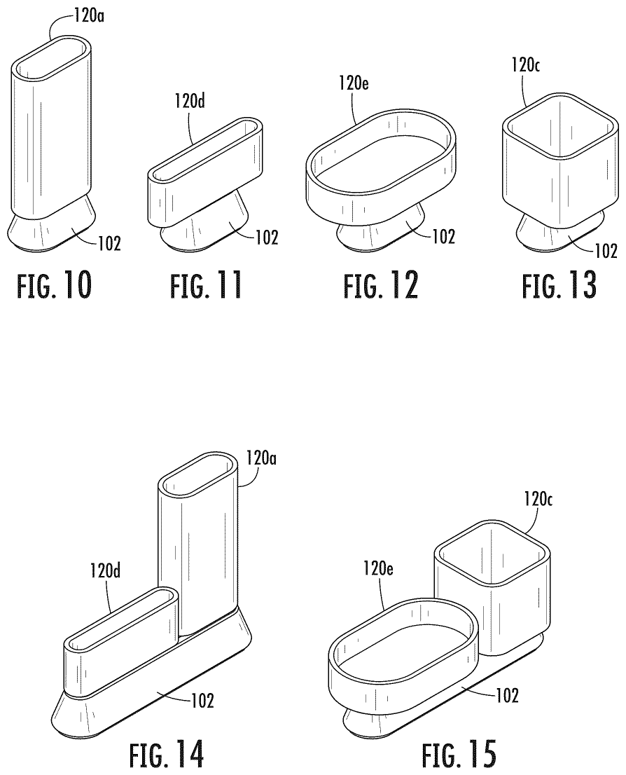

Referring to the drawings, FIGS. 10-13 illustrate various embodiments of the organization system 100 having a base 102 and one of receptacles 120a, 120c-e. The slot (not shown) of the base 102 is sized to securely receive the stem (not shown) of the receptacles 120a, 120c-e.

Referring to the drawings, FIGS. 14-15 show various embodiments of the organization system 100 having a base 102 and one of two sets of receptacles (120a and 120d, or 120c and 120e). In an embodiment, as shown in FIG. 14, the slot (not shown) of the base 102 may be sized to securely receive receptacles 120a, 120d. In another embodiment, as shown in FIG. 15, the slot (not shown) of the base 102 may be sized to securely receive receptacles 120c, 120c. It should be understood that other pairs of receptacles 120a-e may be secured in the base 102.

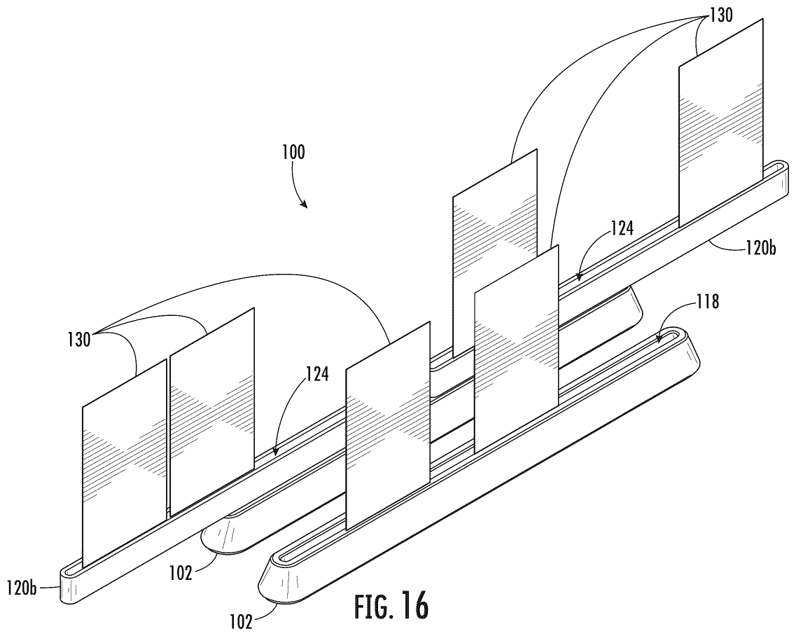

Referring to the drawings, FIG. 16 illustrates the use of the base 102 configured to support a sheet 130 within the slot 118. In another embodiment, a pair of receptacles 120b may be connected to the base 102; wherein the cavity 124 of the receptacles 120b are configured to support one or more sheets 130.

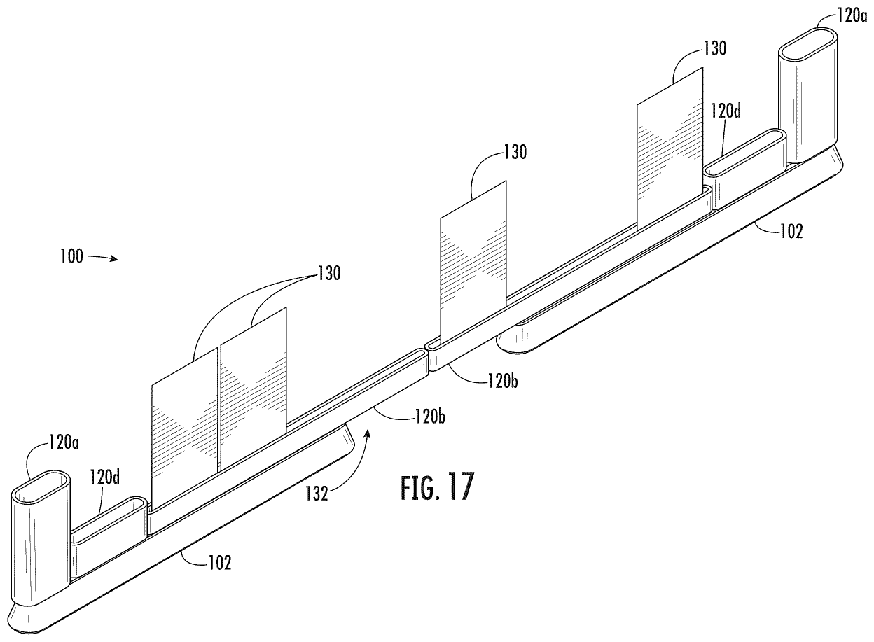

Referring to FIG. 17 in an embodiment of the disclosed subject matter, the organization system 100 may comprise a pair of bases 102, wherein each base of the pair of bases includes a slot. A plurality of receptacles 120b may be connected to each base of the pair of bases. The receptacles of the plurality of receptacles 120b may abut each other to create a void 132 below the plurality of receptacles 120b and between the bases 102. The void 132 may be used to assist in the organization of office supplies and equipment on a working surface (not shown). For example, the base of a computer monitor (not shown) may be positioned within the void 132 to create additional working space on a working surface.

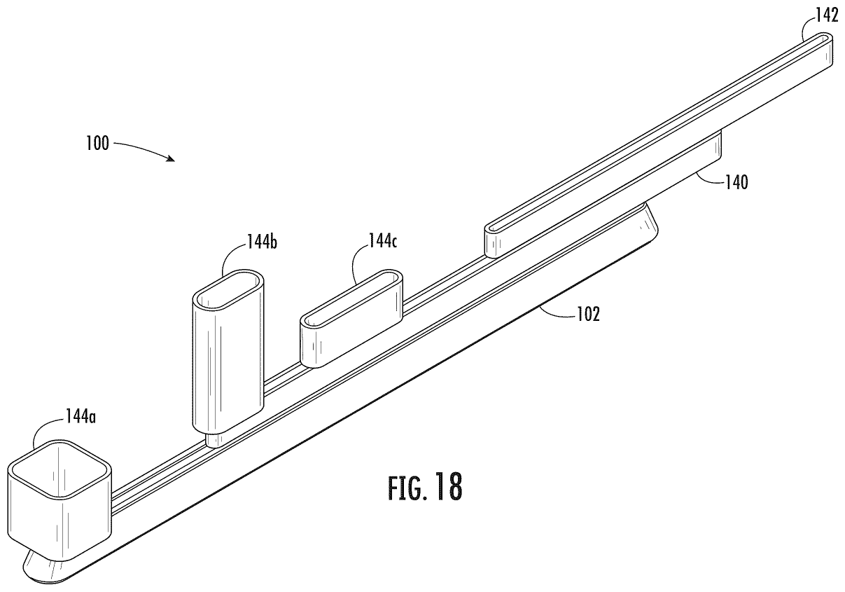

Referring to the drawings, FIG. 18 illustrates an organization system 100 having a base 102; a first receptacle 140 connected to the base; and a second receptacle 142 connected to the first receptacle 140. In an embodiment, one of a third receptacle 144a-c may be connected to one of the base 102, the first receptacle 140, and the second receptacle 142.

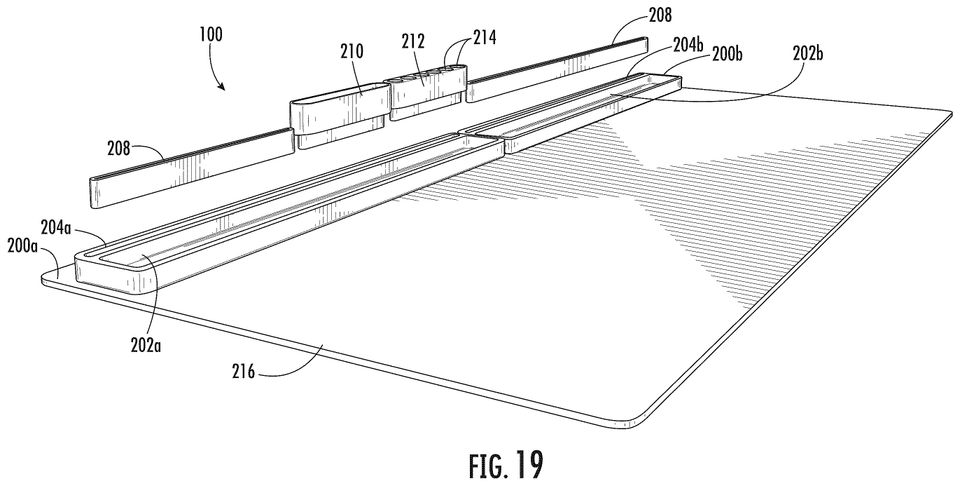

Referring to the drawings, FIG. 19 illustrates an organization system 100 comprising a first tray 200a having a first compartment 202a and a first slot 204a. The first compartment 202a partially extending along the length of the first tray 200a. The first slot 204a parallel to the first compartment 202a and partially extending along the length of the first tray 200a. The organization system 100 may further comprise a second tray 200b having a second compartment 202b and a second slot 204b. The second compartment 202b partially extending along the length of the second tray 200b. The second slot 204b parallel to the second compartment 202b and partially extending along the length of the second tray 200b. The organization system 100 further comprising an accessory 206 configured to partially fit within one of the first slot 204a and the second slot 204b. The accessory 206 may comprise a card rail 208 configured to secure a planar body (not shown), such as, by way of example, note cards or paper sheets in a generally upright position. The accessory 206 may comprise a storage compartment 210 configured for the storage of office supplies and/or stationary. The accessory 206 may comprise a storage container 212 have a plurality of storage bins 214. It is understood that the accessory 206 may comprise other desk organization solutions, such as pen holders and storage compartments of various sizes. In an embodiment the organization system 100 may include a desk mat 216 for supporting at least one of the first tray 200a and the second tray 200b.

It is to be understood that while certain aspects of the disclosed subject matter have been shown and described, the disclosed subject matter is not limited hereto and encompasses various other embodiments as aspects.

Having described the disclosed subject matter, what is claimed as new and desired to be secured by Letters Patent is:

1. An organization system comprising:
a base comprising:
a top surface;
a bottom surface approximately parallel to the top surface; and
a slot extending downwardly from the top surface; and
an attachment body having a stem, wherein the stem is demountably connected to the base within the slot.

2. The organization system of claim 1, wherein the base comprises an exterior sidewall extending outwardly between the top surface and the bottom surface.

3. The organization system of claim 2, wherein the base comprises a pair of end sections connected between a front face and a rear face of the base, wherein each end section of the pair of end sections are curved between the front face and the rear face.

4. The organization system of claim 1, wherein the attachment body comprises:
a receptacle having a length, a width, and a height; and
a cavity extending downwardly into the receptacle.

5. The organization system of claim 4, wherein the length is approximately equal to the width.

6. The organization system of claim 4, wherein the length is greater than the width.

7. The organization system of claim 5, wherein the length is greater than the height.

8. The organization system of claim 7, wherein a portion of the receptacle laterally extends a first distance from the base; wherein the first distance is between about 0 and 80 percent of the length.

9. The organization system of claim 4, wherein in the length is greater than the height, and wherein the height is greater than the width.

10. The organization system of claim 4, wherein a midpoint of the stem is offset a predetermined distance from the midpoint of the receptacle.

11. The organization system of claim 4, further comprising a second receptable configured to connect to the receptacle.

12. An organization system comprising:
a pair of bases, each base of the pair of bases having a slot; and
a plurality of receptacles connected to the pair of bases,
wherein a void is formed below the plurality of receptacles.

13. The organization system of claim 12, wherein each receptacle of the plurality of receptacles comprises a cavity extending along a portion of a length of the receptacle.

14. An organization system comprising:
a first tray comprising:
a first compartment; and
a first slot parallel to the first compartment; and
an accessory configured to partially fit within the first slot.

15. The organization system of claim 14, wherein the accessory comprises a card rail.

16. The organization system of claim 14, wherein the accessory comprises a storage compartment.

17. The organization system of claim 14, wherein the accessory comprises a storage container having a plurality of storage bins.

18. The organization system of claim 14, further comprising a desk mat for supporting the first tray.

19. The organization system of claim 14, further comprising:
a second tray comprising:
a second compartment; and
a second slot parallel to the second compartment; and
an accessory configured to partially fit within the second slot.

20. The organization system of claim 19, further comprising a desk mat for supporting the first tray and the second tray.
